(19) United States
(12) Patent Application Publication
(10) Pub. No.: US 2012/0301265 A1
(43) Pub. Date: Nov. 29, 2012

(54) MOUNTING APPARATUS FOR RECREATIONAL WATER VESSELS

(76) Inventor: Charles Hugh McAnoy, Banksia Beach (AU)

(21) Appl. No.: 13/470,909

(22) Filed: May 14, 2012

(30) Foreign Application Priority Data
May 24, 2011 (AU) AU2011901998
Jun. 2, 2011 (AU) AU2011902143

(51) Int. Cl. B60R 9/08; B60P 1/64

(52) U.S. Cl. 414/812; 224/559; 224/548; 224/310

(57) ABSTRACT

A mounting apparatus 10 is provided for assisting in sliding a kayak up onto a roof rack. The mounting apparatus comprises a vehicle mounting portion 11, and a cradling portion 12. Vehicle mounting portion 11 comprises a central support portion 13, and a pair of oppositely extending suction assemblies 14. Each suction assembly 14 comprises a lower flexible cup like foot portion 15 which attaches to the vehicle, and an upper backing member 16 which is made of metal. An operating member 17 is attached to each backing member 16 and comprises an over centre cam like lever 18 which can be moved between a first position where portion 15 is held to the vehicle by suction, and a second (release) position where the foot portion can be removed from the attachment to the vehicle.

### CROSS-REFERENCE TO RELATED APPLICATIONS

This application claims the benefit of Australian Patent Application Serial No. AU 2011901998 filed on May 24, 2011, and Australian Patent Application Serial No. AU 2011902143 filed on Jun. 2, 2011.

### TECHNICAL FIELD OF THE INVENTION

The present invention is directed to a mounting apparatus for recreational water vessels such as kayaks, canoes and the like, and which can assist in loading the vessel to a land vehicle such as a car. In a non-limiting particular form, the invention may be directed to an apparatus for mounting a kayak.

### BACKGROUND OF THE INVENTION

Recreational water vessels such as kayaks, canoes, sailboards and the like are usually too large to be transported inside a car. Because of the size of the vessels, some form of mounting device is usually required which is attached to the roof of the car, and the vessel is secured to the mounting device typically using straps and the like. In particular, it is common for the vessels to be transported on roof racks fitted on the top of the car.

A problem encountered in the use of this type of transportation arrangement is that the weight of the water vessel is typically such that it is difficult if not impossible for a single person to lift the vessel up to the roof racks of the car. The lifting difficulty is particularly apparent with respect to SUV's where the distance between the ground to the roof racks can be up to 2 m and the person needs to be strong enough and tall enough to physically lift the vessel onto the roof racks. Scratching or damage to the can occur should the water vessel be lifted on to the roof racks by a single person. Furthermore, it is common to manufacture water vessels from fibreglass which is light and strong but which is relatively easily damaged should the vessel be dropped accidentally.

It is known to provide a rather complicated side lifting device which can be temporarily attached to a cradle which is already attached to roof racks. The water vessel is initially lifted into the side lifting device and progressively lifted onto the roof racks. The arrangement has several disadvantages including the need for the user to be strong enough and tall enough to physically lift the vessel up the side lifting device and onto the roof racks.

There would be an advantage if it were possible to provide a mounting apparatus for a kayak and possibly other recreational water vessels which could overcome at least some of the above-mentioned disadvantages or provide a useful or commercial choice.

Any references to methods, apparatus or documents of the prior art are not to be taken as constituting any evidence or admission that they formed, or form part of the common general knowledge.

### SUMMARY OF THE INVENTION

According to a first aspect of the present invention there is provided a mounting apparatus to assist in mounting a recreational water vessel to a vehicle, the apparatus comprising a vehicle mounting portion and a vessel cradling portion, the vehicle mounting portion comprising at least one suction member adapted to be releasably attached to the vehicle using suction.

According to a second aspect of the present invention there is provided a recreational water vessel to a vehicle, the assembly comprising an upper mounting apparatus adapted to be removeably mounted to a roof of the vehicle, a lower mounting apparatus adapted to be removeably mounted to the vehicle at a position below the upper mounting apparatus, each mounting apparatus having mounting means to removeably mount the apparatus to the vehicle, and a cradle portion to support part of the water vessel.

According to a third aspect of the present invention there is provided a method to raise a water vessel to a roof of a vehicle, the method comprising providing an upper mounting apparatus adapted to be releasably attached to a, or proximal to, a roof of the vehicle, and a lower mounting apparatus adapted to be releasably attached to a portion of the vehicle which is below the roof, lifting one end of the vessel onto the lower mounting apparatus, moving the vessel to engage with the upper mounting apparatus, and sliding and pivoting it upon the upper mounting apparatus so that it rests at roof level on the vehicle.

In this manner, the upper mounting apparatus can be mounted proximal to, or on, the roof of a vehicle (e.g. a car) and the lower mounting apparatus can be attached to a lower portion of the vehicle (e.g. the boot/trunk/rearward part of the vehicle), and the water vessel (e.g. kayak) can be quite easily lifted onto the lower mounting apparatus (which is positioned below the roof height) and can then be pushed along/against or over the lower mounting apparatus until a part of the vessel is supported by the upper mounting apparatus. The vessel can then be readily slid onto the roof racks of the vehicle and secured thereto. Thus, there is no need to lift the entire vessel onto the roof of the vehicle. Instead, preferably a forward end of the vessel is firstly lifted onto the lower mounting apparatus. The trailing end of the vessel may then be lifted from the ground. The hull of the vessel may then be slid over the lower mounting apparatus until the front of the vessel is supported by the upper mounting apparatus. The vessel can then be slid and pivoted over the upper mounting apparatus until it is received on the roof or roof racks of the vehicle. Unloading of the water vessel from the vehicle is also easier as the procedure may be performed in reverse if desired. It is not necessary to lift the vessel off the roof of the vehicle.

The mounting apparatus is particularly suited for kayaks. There are many different types of kayaks available in the marketplace and FIG. 1 illustrates a typical known type of kayak which could be suitable. However, the mounting apparatus may also be used for other types of water vessels. These might include canoes, sailboards, and other types of vessels which could benefit from the mounting apparatus according to the present invention.

While present invention will be described with reference to a recreational water vessel, there may be circumstances where the mounting apparatus would be suitable for assisting in the loading and unloading of other types of loads which may otherwise need to be lifted to roof level but which, with the present invention, can be slid up and on to other mounting apparatus such as roof racks.

The vehicle will typically comprise a motor vehicle. The motor vehicle may include a sedan, a wagon, a hatchback, a SUV, and the like. Other types of motor vehicles may also be suitable. In some circumstances, the vehicle may comprise a trailer or other type of towed vehicle and particularly of the type which comprises a roof onto which the vessel can be fitted. They may also be circumstances where the vehicle comprises a water vehicle which may benefit from the mounting apparatus of the present invention.

In one aspect of the invention the mounting apparatus comprises a vehicle mounting portion and a vessel cradling portion. The vehicle mounting portion preferably comprises at least one and typically two or more suction members which can releasably attach to part of the vehicle. The suction member may comprise a somewhat flexible foot portion engageable to the vehicle, and a backing member to which the foot portion is attached. The backing member may support at least one operating member which can be operated between a suction position where the foot portion is attached to the vehicle using suction, and a free position where the foot portion can be released from the vehicle.

The vehicle mounting portion may comprise a support part which can support the at least one suction member. The at least one suction member may be adjustably supported relative to the support part to enable the mounting portion to conform to different vehicle shapes.

The vessel cradling portion may have a shape and configuration to support part of the vessel. Typically, the portion will support the bottom or hull portion of the vessel. It is preferred that the vessel cradling portion will support at least part of the side wall of the vessel. Thus, the vessel cradling portion may comprise at least one arm member, and preferably a pair of oppositely extending arm members to support/cradle a bottom part of the kayak or other type of vessel.

In a simple form of the invention, the mounting apparatus according to the present invention may be attached to the boot/trunk portion of the vehicle. The vehicle will preferably be provided with a roof rack to receive the vessel which is slid over the mounting apparatus and up onto the roof rack in use. The kayak can then be secured in position, for example readily lifted onto the conventional roof racks mounted on the vehicle without needing to entirely lift the kayak from the ground to roof height.

It is preferred that the present invention comprises at least two such mounting apparatus, one releasably mounted to the roof of the vehicle and another releasably mounted to a lower portion (e.g. boot/trunk) of the vehicle.

The mounting apparatus may comprise means to facilitate sliding or other movement of the vessel over the mounting apparatus. Thus, parts of the mounting apparatus may be made of smooth material. It is also envisaged that part of the mounting apparatus may comprise a low friction portion. That is a portion having a low coefficient of friction. The low friction portion may be formed separately and attached to part of the mounting apparatus. It is envisaged that the low friction portion can be removably attached to the mounting apparatus. Part of the mounting apparatus may also contain at least one grip enhancing portion. The grip enhancing portion may be formed separately and attached to part of the mounting apparatus. It is envisaged that the grip enhancing portion can be removably attached to the mounting apparatus. It is also envisaged that the grip enhancing portion and the low friction portion may be interchanged as desired and depending on the situation and factors such as the weight of the vessel.

The mounting apparatus can be made of any suitable material. For instance, part of the mounting apparatus such as the vessel cradling portion may be made from plastics material such as polyethylene or polypropylene. However, it is not considered that any particular limitation should be placed on the materials used in the manufacture of the apparatus merely by exemplification of certain suitable materials.

If required, the vessel can be held in place by the use of securement means. The securement means may comprise straps or other types of locking members. The securement means may comprise part of the mounting apparatus or may be separate therefrom.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1. Illustrates a typical prior art water vessel (kayak).

FIG. 2. Illustrates an upper view of a mounting apparatus according to an embodiment of the invention.

FIG. 3. Illustrates a side view of the mounting apparatus of FIG. 2.

FIG. 4. Illustrates an underneath view of the mounting apparatus of FIG. 2.

FIG. 5. Illustrates another underneath view of the mounting apparatus of FIG. 2.

FIG. 6. Illustrates an upper view of a mounting apparatus according to a slightly different embodiment of the invention.

FIG. 7. Illustrates a side view of the mounting apparatus of FIG. 6.

FIG. 8. Illustrates an underneath view of the mounting apparatus of FIG. 6.

FIG. 8A Illustrates a view of a further embodiment of the apparatus.

FIG. 9. Illustrates a first of the mounting apparatus located adjacent a roof of a vehicle for assisting in loading of a kayak onto the roof racks shown on the vehicle.

### DETAILED DESCRIPTION OF THE INVENTION

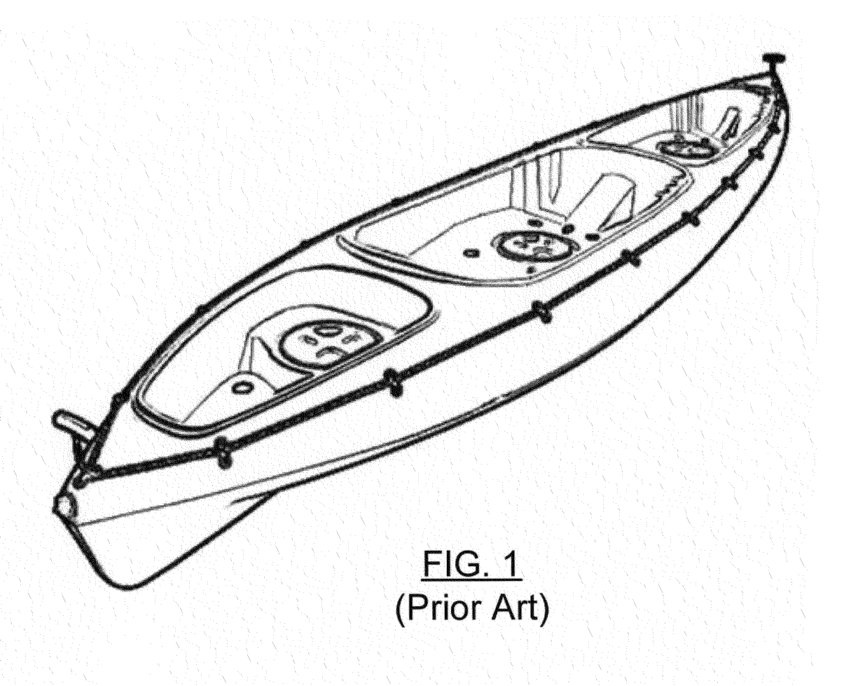

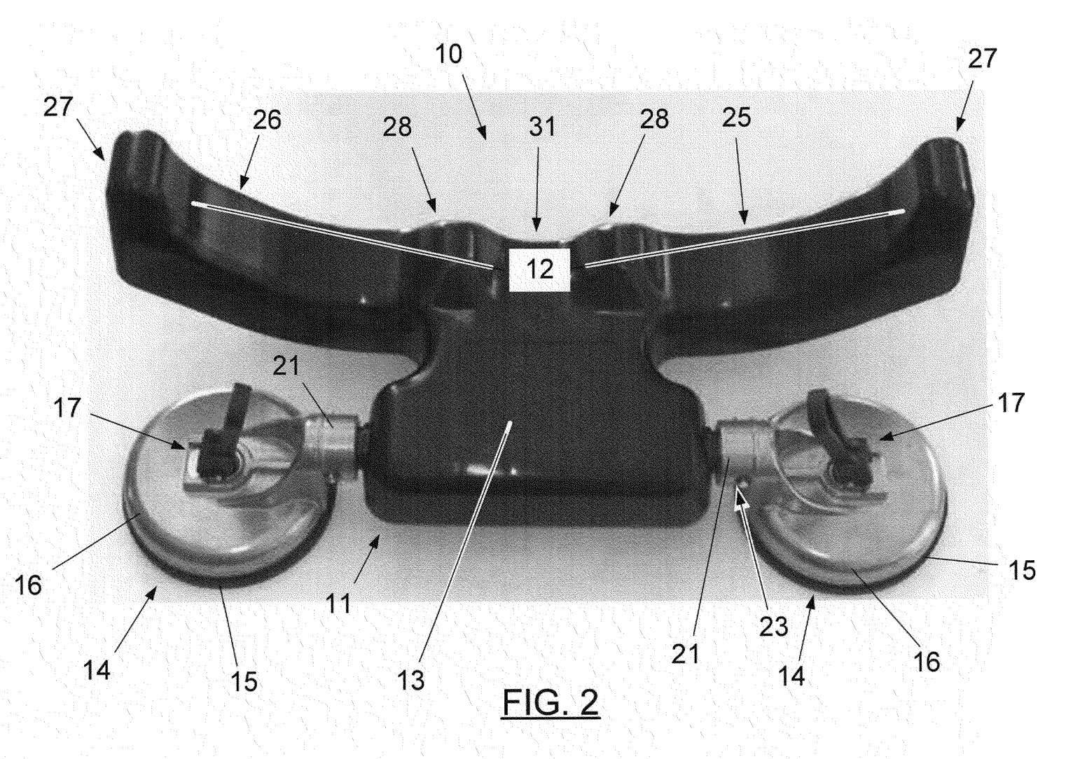

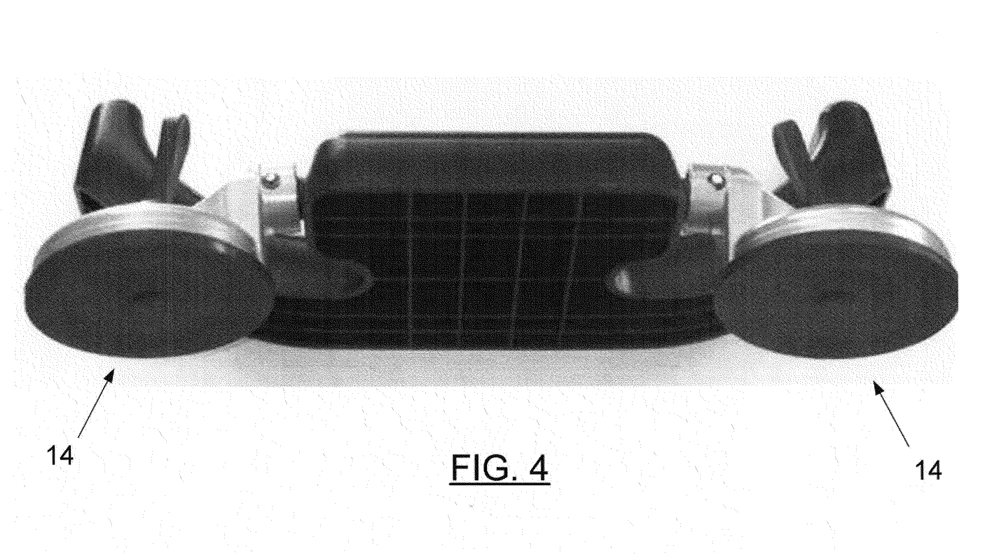

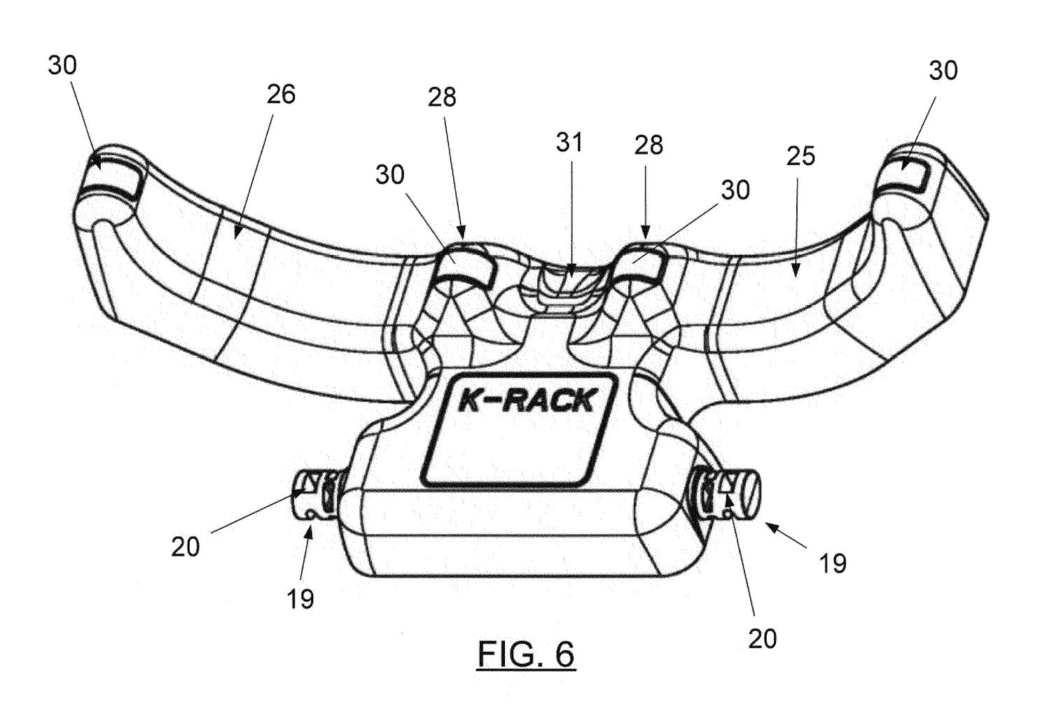

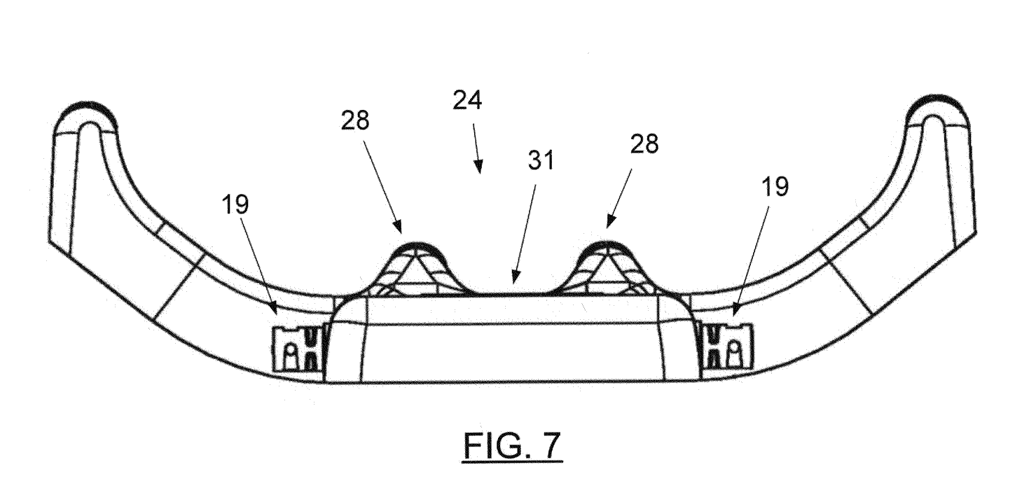

Referring to the figures, FIG. 1 illustrates a known type of kayak, FIGS. 2-5 illustrate a first embodiment of the invention, and FIGS. 6-8 illustrate a slightly different second embodiment of the invention.

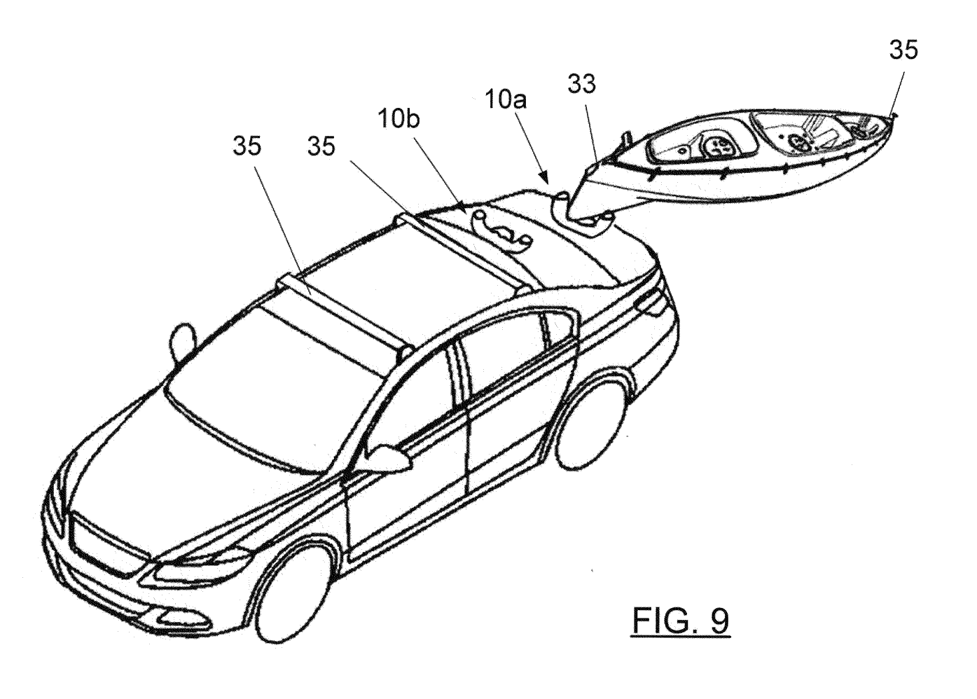

Referring initially to FIGS. 2-5, there is illustrated a mounting apparatus 10 adapted for attachment to a vehicle. In the use of the invention, a pair of such mounting apparatus 10 will be provided, one attached adjacent the roof of a vehicle (e.g. on the uppermost portion of a rear window as shown in FIG. 9) and the other attached to a lower portion of the vehicle (typically the boot/trunk) (as shown in FIG. 9). Mounting apparatus 10 comprises a vehicle mounting portion 11, and a cradling portion 12. Vehicle mounting portion 11 comprises a central support portion 13, and a pair of oppositely extending suction assemblies 14. Each suction assembly 14 comprises a lower flexible cup like foot portion 15 which attaches to the vehicle, and an upper backing member 16 which is made of metal. An operating member 17 is attached to each backing member 16 and in the particular preferred embodiment comprises an over centre cam like lever 18 which can be moved between a first position where portion 15 is held to the vehicle by suction, and a second (release) position where the foot portion can be removed from the attachment to the vehicle.

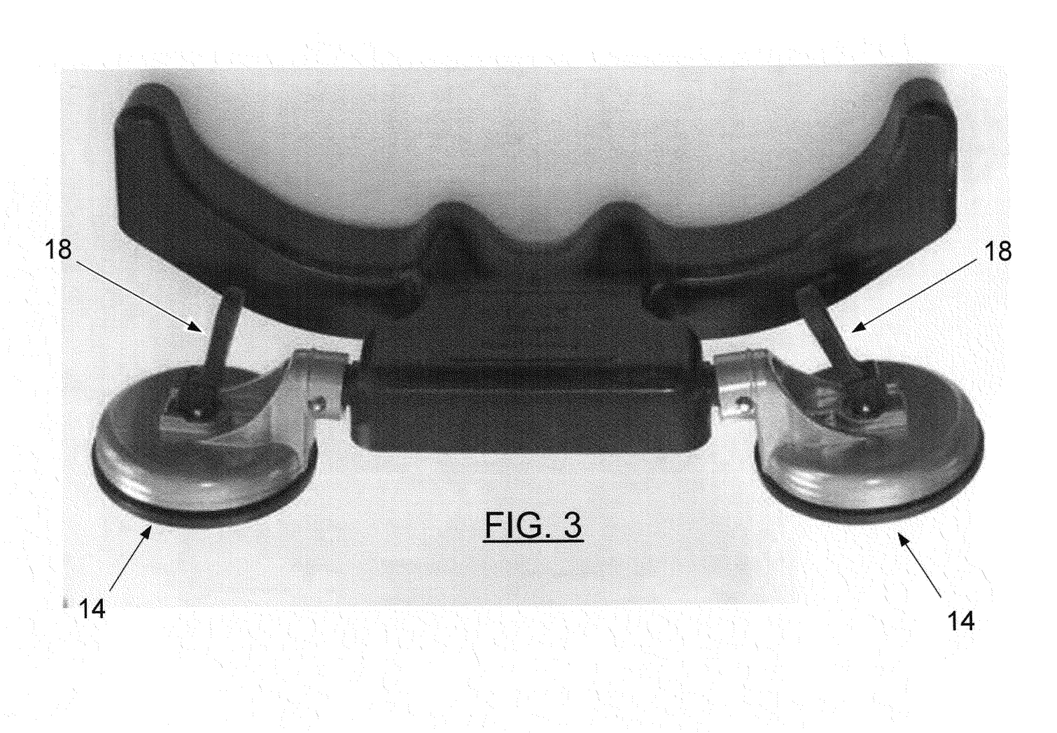

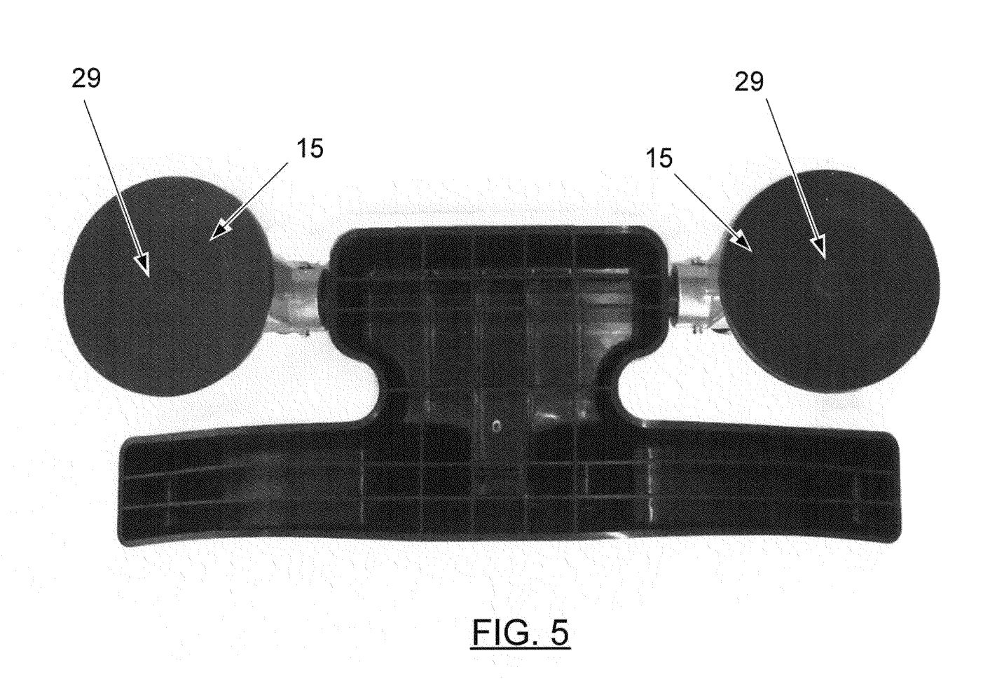

Specifically and best illustrated in FIGS. 3 and 5, lever 18 (see FIG. 3) has a stem portion which is, within backing member 16 attached to a respective foot portion 29 (indicated in FIG. 5). Positioning of the levers 18 in the upright position (illustrated in FIG. 3) allows the foot portion to adopt a relatively planar and therefore released position while rotating levers 18 downwardly to lie against backing member 16 causes foot portion 29 to be pulled into a concave position and therefore become attached to the vehicle using suction.

The arrangement of the over centre mechanism prevents inadvertent release of the apparatus.

In use, the mounting apparatus 10 can be placed on a smooth panel of the vehicle and levers 18 can be operated to lock the mounting apparatus to the vehicle using suction.

Each suction assembly 14 is mounted to a steel pin 19 (best illustrated in FIG. 6. In the embodiment shown in FIGS. 6 to 8 each pin 19 is provided with elongated openings 20. Each backing member 16 has a collar 21 (FIG. 2) which sits over a respective steel pin 19 to fit the suction assembly 14 to the support portion 13. Collar 21 is provided with a small opening through which a small screw (or similar) 23 (see FIG. 2) can pass to attach the collar to the respective pin 19. Screw 23 sits within an elongate opening 20 and this enables the suction assembly 14 to pivot to some degree about steel pin 19.

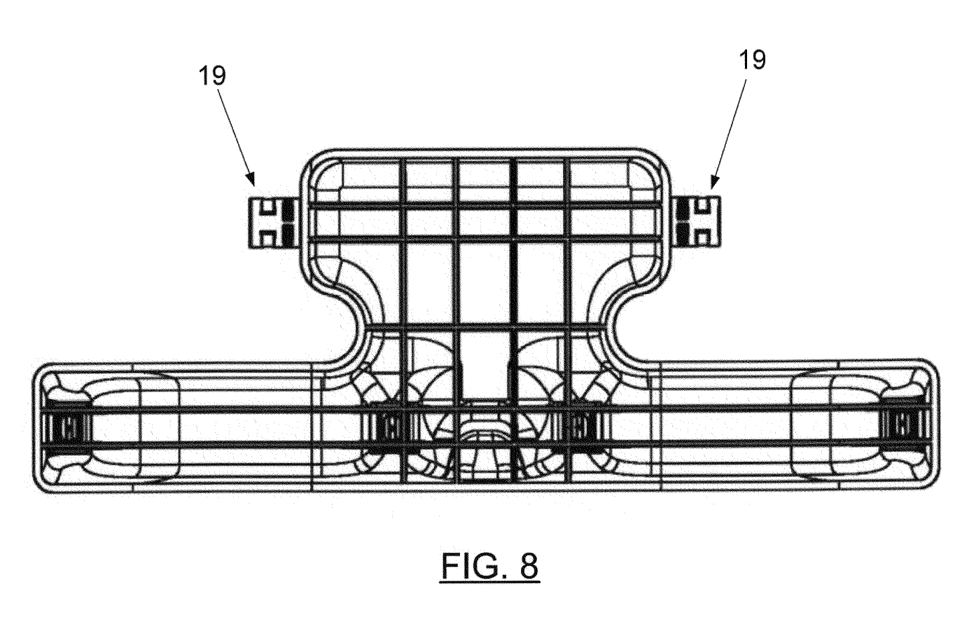

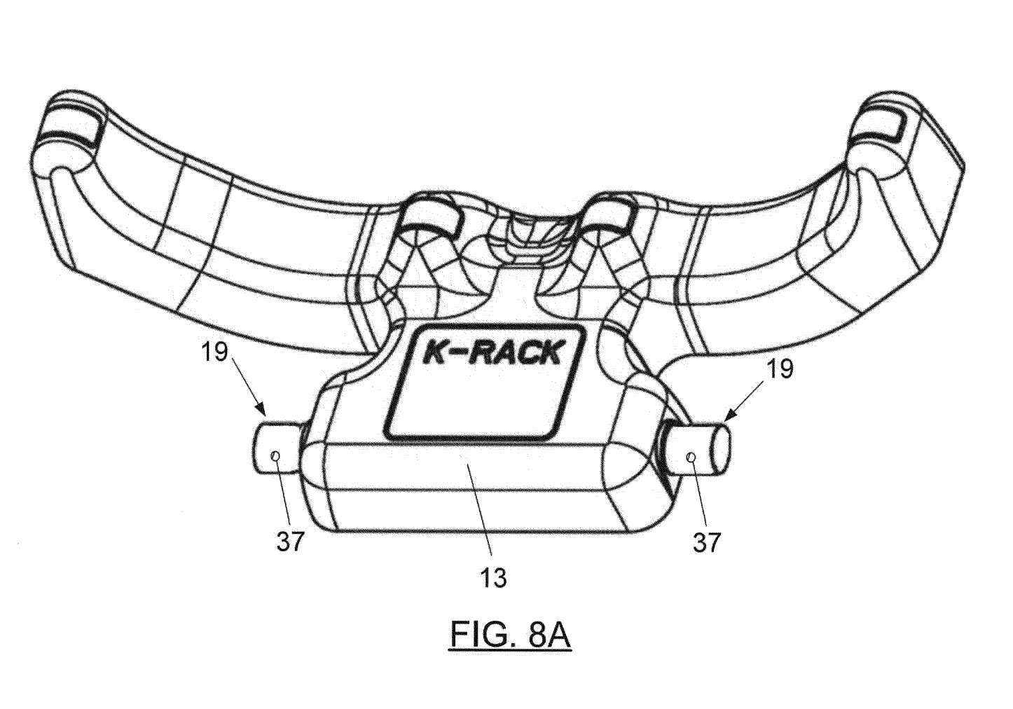

In the preferred embodiment shown in FIG. 8A each pin 19 is integrally formed with the plastic body of the support portion 13 and is formed with a hole 37 therethrough. The backing member collars 21 fit over the plastic pins 19 and are secured thereto by pins that locate through the holes 37. Some play is provided for the collars 21 on the pins 19 so that the suction assemblies 14 can move to accommodate the shape of the surface to which they are attached.

Mounting apparatus 10 further comprises cradling portion 12. In the particular embodiment, cradling portion 12 and support portion 13 are formed integrally and can be made of plastics material such as polyethylene or polypropylene. However, other suitable materials are also envisaged.

Cradling portion 12 comprises a central portion (see below) and a pair of oppositely extending arm members 25, 26. Arm members 25, 26 are curved and made of smooth plastic material. The end of each arm member 25, 26 contains a thickened portion 27.

The central portion 24 comprises a pair of spaced apart raised portions 28 defining a valley 31 therebetween. This configuration can assist in supporting the lowermost portion of the hull of the kayak.

If desired, and referring to FIG. 6, each arm member 25, 26 and raised portion 28 can be provided with a removable insert 30. Insert 30 can comprise a removable member, and the member can comprise either a low friction material (for example Teflon) or can comprise a grip enhancing material. Thus, a low friction insert or a grip enhancing insert may be used as the situation requires.

In use, (and particularly referring to FIG. 9) an upper mounting apparatus 10b can be attached to adjacent the rear of the roof of a vehicle. A lower mounting apparatus 10a (as shown in FIG. 9) can be attached to the goods/trunk of the vehicle. A kayak can then be lifted at leading end 33 from ground level and such that it is placed on the cradling portion 12 of the lower mounting apparatus 10 as shown in FIG. 9. This lift will be relatively easy as only one end of the kayak is lifted and the lift height is only to the boot/trunk level of the vehicle. The trailing end 35 of the kayak can then be lifted from the ground and the kayak hull can be slid over the lower mounting apparatus 10b by a relatively easy pushing action until the leading end 33 of the kayak moves into the cradling portion 12 of the upper mounting apparatus 10b which is on the upper limit of the vehicle rear window adjacent the roof of the vehicle. The kayak can then be slid further up and its forward end pivoted down about the upper mounting apparatus 10b until it is brought to rest on the conventional roof racks 35 to which it is then secured in the conventional fashion.

Thus, it is now possible for a single person to transport a kayak on a vehicle without requiring lifting of the kayak onto the roof racks of the vehicle. The mounting apparatus can be quite easily attached and removed from the vehicle and will not take up much space in the vehicle. The mounting apparatus can be positioned on the left-hand side or the right hand side of the vehicle and can even be positioned elsewhere.

In compliance with the statute, the invention has been described in language more or less specific to structural or methodical features. The term “comprises” and its variations, such as “comprising” and “comprised of” is used throughout in an inclusive sense and not to the exclusion of any additional features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

In a further embodiment of the invention the cradling portion may be designed differently. For example, in an alternative embodiment the cradling portion may comprise a roller, formed with a medial groove to complement the apex of the hull of the vessel.

Throughout the specification and claims (if present), unless the context requires otherwise, the term “substantially” or “about” will be understood to not be limited to the value for the range qualified by the terms.

Any embodiment of the invention is meant to be illustrative only and is not meant to be limiting to the invention. Therefore, it should be appreciated that various other changes and modifications can be made to any embodiment described without departing from the spirit and scope of the invention.

What is claimed is:

1. A mounting apparatus for assisting in mounting a recreational vessel to a vehicle comprising:
a vehicle mounting portion;
and a vessel cradling portion;
wherein the vehicle mounting portion comprises at least one suction member adapted to be releasably attached to the vehicle by suction.

2. An apparatus according to claim 1, wherein the vehicle mounting portion comprises at least two suction members which can releasably attach to part of the vehicle.

3. An apparatus according to claim 1 or claim 2, wherein each said suction member comprises a somewhat flexible foot portion engageable to the vehicle, and a backing member to which the foot portion is attached.

4. An apparatus according to claim 1, wherein the vehicle mounting portion comprises a support part which can support the at least one suction member.

5. An apparatus according to claim 4, wherein the at least one suction member is adjustably supported relative to the support part to enable the mounting portion to conform to different vehicle shapes.

6. An apparatus according to claim 1, wherein the cradling portion is formed with a shape to complement the bottom or hull portion of the vessel.

7. An apparatus according to claim 6, wherein the cradling portion comprises a pair of oppositely extending arm members to support a bottom part of the vessel.

8. An apparatus according to claim 1, wherein the vessel cradling portion is formed to receive one or more removable inserts for presenting a surface of predetermined friction coefficient to the vessel.

9. A mounting assembly to assist in mounting a recreational water vessel to a vehicle, the assembly comprising:
an upper mounting apparatus adapted to be removeably mounted on or adjacent a roof of the vehicle;
a lower mounting apparatus adapted to be removeably mounted to the vehicle at a position below the upper mounting apparatus;
wherein each mounting apparatus includes a mounting arrangement to removeably mount the apparatus to the vehicle, and a cradle portion to support part of said vessel.

10. An assembly according to claim 9, wherein the vehicle mounting portion of each said apparatus comprises at least one suction member which can releasably attach to part of the vehicle.

11. An apparatus according to claim 10, wherein each said suction member comprises a somewhat flexible foot portion engageable to the vehicle, and a backing member to which the foot portion is attached.

12. An apparatus according to claim 11, wherein the vehicle mounting portion of each said mounting apparatus comprises a support part which can support the at least one suction member.

13. An apparatus according to claim 12, wherein the at least one suction member is adjustably supported relative to the support part to enable the mounting portion to conform to different vehicle shapes.

14. A method to raise a water vessel to a roof of a vehicle, the method comprising:
providing an upper mounting apparatus adapted to be releasably attached to, or proximal to, a roof of the vehicle, and a lower mounting apparatus adapted to be releasably attached to a portion of the vehicle which is below the roof;
lifting one end of the vessel onto the lower mounting apparatus,
moving the vessel to engage with the upper mounting apparatus, and sliding and pivoting it upon the upper mounting apparatus so that it rests at or above roof level on the vehicle.
